(19) United States
(12) Patent Application Publication
(10) Pub. No.: US 2018/0315083 A1
(43) Pub. Date: Nov. 1, 2018

(54) METHOD TO MAXIMIZE MESSAGE SPREADING IN SOCIAL NETWORKS AND FIND THE MOST INFLUENTIAL PEOPLE IN SOCIAL MEDIA

(71) Applicant: Research Foundation of the City University of New York, New York, NY (US)

(72) Inventors: Hernan A. Makse, North Brunswick, NJ (US); Flaviano Morone, New York, NY (US)

(21) Appl. No.: 16/019,075

(22) Filed: Jun. 26, 2018

Related U.S. Application Data
(63) Continuation-in-part of application No. 14/992,369, filed on Jan. 11, 2016.
(60) Provisional application No. 62/671,772, filed on May 15, 2018.
(60) Provisional application No. 62/101,756, filed on Jan. 9, 2015.

(51) Int. Cl. G06Q 30/02; G06Q 50/00; G06F 17/30

(52) U.S. Cl. CPC G06Q 30/0254; G06Q 30/0267; G06F 17/30867; G06F 17/3053; G06Q 50/01

(57) ABSTRACT

A method is provided to maximize the spreading of information in social networks. The method identifies the most influential nodes by introducing a ranking method based on collective behavior of nodes in a social network. The method is then used to identify the minimal set of such nodes that are able to spread information in the network.

### CROSS-REFERENCE TO RELATED APPLICATIONS

This application claims priority to and is a non-provisional of U.S. Patent Application Ser. No. 62/671,772 (filed May 15, 2018) and is also a continuation-in-part of U.S. patent application Ser. No. 14/992,369 (filed Jan. 11, 2016) which is a non-provisional of U.S. Patent Application Ser. No. 62/101,756 (filed Jan. 9, 2015) the entirety of which are incorporated herein by reference.

### STATEMENT OF FEDERALLY SPONSORED RESEARCH OR DEVELOPMENT

This invention was made with Government support under contract number NSF-PHY #1305476 awarded by the National Science Foundation; Contract Number W911NF-09-2-0053 awarded by the Army Research Laboratory and Contract Number NIH-NIGMS 1R21GM107641-01 awarded by the National Institute of Health. The government has certain rights in the invention.

### BACKGROUND OF THE INVENTION

The subject matter disclosed herein relates to social networking and, more particularly, to the viral distribution of data within a social network.

Information spreading is an ubiquitous process in society which describes a variety of phenomena ranging from the adoption of innovations, the success of commercial promotions, the rise of political movements, and the spread of news, opinions and brand new products in society. In these phenomena, starting from a few “seeds”, the information spreads from person to person contagiously and may eventually reach the majority of population in a “viral” way. As such, how people contact each other in a social network is of great significance in information spreading processes. However, not all people are equally important in a social network. Some influential individuals stand out due to their prominent ability to spread opinion to the largest populations. The ability to initiate a “viral” spreading process starting at these most influential individuals is attributed to the spreader's unique location in the underlying social network. Targeting these most influential people in information dissemination is crucial for designing strategies for accelerating the speed of propagation in product promotion during advertisement and marketing campaigns in online social networks. Therefore, identification of the most influential spreaders in social networks is of great practical importance.

A number of different measures aimed at identifying influential spreaders were suggested over the years. The most prominent ones include the degree of an individual (number of links, connections or friends in a social network), PAGERANK®, and betweenness centrality. Degree is the most direct and widely-used topological measure of influence. In a social network with a broad degree distribution, the most connected people or hubs are usually believed to be responsible for the largest spreading processes. PAGERANK® is a network-based diffusion method which describes a random walk process on hyperlinked networks. Although, it was originally proposed to rank content in the World Wide Web and stimulated the revolution in the web search industry contributing to the emergence of the search giant GOOGLE®, PAGERANK® is applied in many circumstances to rank an extensive array of data. Due to their straightforward implementation, researchers use the degree and PAGERANK® to identify influential individuals in social networks in many practical situations. Betweenness centrality is defined as a measure of how many shortest paths cross through a node and is also used to identify the influential individuals by their high betweeness centrality.

A major drawback of the above referenced methods is the inability to capture the collective behavior of identified influential nodes and the detection of optimal set of multiple influencers providing full network coverage according to a given information spreading protocol. Thus, the widely-used degree centrality and PAGERANK® methods fail in ranking users' influence.

The discussion above is merely provided for general background information and is not intended to be used as an aid in determining the scope of the claimed subject matter.

### BRIEF DESCRIPTION OF THE INVENTION

A method is provided to maximize the spreading of information in social networks. The method identifies the most influential nodes by introducing a ranking method based on collective behavior of nodes in a social network. The method is then used to identify the minimal set of such nodes that are able to spread information in the network. An advantage that may be realized in the practice of some disclosed embodiments of the method is that influential spreaders of information in a large social network can be more easily identified for subsequent distribution of data.

In a first embodiment, a method of target marketing in a social network is provided. The method comprises steps of: determining a topological structure of a social network, wherein the social network comprises a plurality of individuals including influential spreaders of information; calculating a collective influence (CI) value for each individual (i) on other individuals (j) in the social network according to:

[symbol]

(i)=(kᵢ−1) [symbol] (kⱼ−1)

wherein ∂Ball(i, [symbol] ) is a ball of radius link ( [symbol] ) around individual (i), the radius link ( [symbol] ) is a non-zero integer corresponding to a number of links to connect individual (i) to other individuals (j) located on a boundary of the ball, kⱼ is a degree of individual (j); rank ordering each individual by their respective CI value, thereby producing a rank ordered list; and sending a targeted advertisement to the individuals in at least the top 10% of the rank ordered list but not sending the targeted advertisement to the individuals in the bottom 50% of the rank ordered list.

In a second embodiment, a method of target marketing in a social network is provided. The method comprises steps of: determining a topological structure of a social network, wherein the social network comprises a plurality of individuals including influential spreaders of information; calculating a collective influence (CI) value for each individual (i) on other individuals (j) in the social network according to:

[symbol]

(i)=(kᵢ−1) [symbol] (kⱼ−1)

wherein ∂Ball(i, [symbol] ) is a ball of radius link ( [symbol] ) around individual (i), the radius link ( [symbol] ) is a non-zero integer corresponding to a number of links to connect individual (i) to other individuals (j) located on a boundary of the ball, kⱼ is a degree of individual (j); rank ordering each individual by their respective CI value, thereby producing a rank ordered list; and sending a targeted advertisement to the individuals in at least the top 20% of the rank ordered list but not sending the targeted advertisement to the individuals in the bottom 50% of the rank ordered list, wherein the targeted advertisement advertises a credit offer.

In a third embodiment, a method of target marketing in a social network is provided. The method comprises steps of: determining a topological structure of a social network, wherein the social network comprises a plurality of individuals including influential spreaders of information; calculating a collective influence (CI) value for each individual (i) on other individuals (j) in the social network according to:

[symbol]

(i)=(kᵢ−1) [symbol] (kⱼ−1)

wherein ∂Ball(i, [symbol] ) is a ball of radius link ( [symbol] ) around individual (i), the radius link ( [symbol] ) is a non-zero integer corresponding to a number of links to connect individual (i) to other individuals (j) located on a boundary of the ball, kⱼ is a degree of individual (j); rank ordering each individual by their respective CI value, thereby producing a rank ordered list; and sending, using a short-message-service (SMS), a targeted advertisement to the individuals in at least the top 10% of the rank ordered list but not sending the targeted advertisement to the individuals in the bottom 50% of the rank ordered list, wherein the targeted advertisement advertises a credit offer.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A depicts the largest eigenvalue λ of [symbol] exemplified on a simple network;

FIG. 1B depicts an example of non-backtracking (NB) walks. A NB walk is a random walk that is not allowed to return back along the edge that it just traversed;

FIG. 1C is a representation of the global minimum over n of the largest eigenvalue λ of [symbol] versus q;

FIG. 1D depicts a ball(i, [symbol] ) of radius [symbol] around node i is the set of nodes at distance [symbol] from i, and ∂Ball is the set of nodes on the boundary;

FIG. 1E is an example of a weak node: a node with a small number of connections surrounded by hierarchical coronas of hubs at different [symbol] levels;

FIG. 2A depicts a Giant component G(q) of TWITTER® users (N=469,013) computed using CI, HDA, PAGERANK®, HD and k-core strategies;

FIG. 2B depicts G(q) for a social network of N=14, 346, 653 mobile phone users in Mexico representing an example of big data to test the scalability and performance of the method in real networks;

FIG. 3A to FIG. 3I depict an example of the execution of the disclosed method;

FIG. 4A a, G(q) in an Erdos-Renyi synthetic network (N=200,000) showing the true optimal solution found with EO (‘x’ symbol), and also using CI, HDA, PR, HD, CC, EC and k-core methods;

FIG. 4B shows G(q) for a Scale-Free synthetic network with N=200,000 nodes;

FIG. 5A is a schematic representation of a network under k-shell decomposition;

FIG. 5B shows an example of the calculation of CI with a CI Ball(i, [symbol] ) of radius [symbol] =3 around node i being the set of nodes contained inside the sphere and ∂Ball is the set of nodes on the boundary and CI is the degree-minus-one of the central node times the sum of the degree-minus-one of the nodes at the boundary of the sphere of influence;

FIGS. 6A-6D are graphs depicting fraction of wealthy individuals versus age and network metrics showing correlation between the fraction of wealthy individuals versus age and (FIG. 6A) degree k (R²=0.92), (FIG. 6B) k-shell (R²=0.96), (FIG. 6C) PAGERANK® (R²=096) and (FIG. 6D) log₁₀ CI (R²=0.93) with only those groups with a population greater than 20 being show in the plot;

FIGS. 7A-7D are graphs of fraction of wealthy individuals over different age and composition ranking groups that correlates the fraction of wealthy individuals as given by the top 25% credit limit and CI in different age groups of (FIG. 7A) 18-30, (FIG. 7B) over 45. Correlations between top economy status and large CI as determined by CI values in different ages are significant in all age groups, while the slope of the linear regression is larger in the older group (0.053 compared to 0.037); FIG. 7C shows age-network composite ranking ANC and FIG. 7D shows age-diversity composite ranking ADC. By combining the network metrics CI with age into a composite index, the chance to identify people of high financial status reaches about 70% for high values of the composite;

FIG. 8 shows response rate versus CI quantile in the real-life CI-targeted marketing campaign with the response rate increases approximately linearly with CI ranking. The CI-targeted campaign shows a threefold gain for the top influencers with high CI, as compared with a campaign targeting a randomized control group.

### DETAILED DESCRIPTION OF THE INVENTION

A method is provided to systematically identify the most influential individuals in a large social network. The successful identification of these influential individuals, in turn, can be used for a number of practical applications. For example, the role of these influential nodes to act as super spreaders in large online social networks such as FACEBOOK® and TWITTER® may be used. Identification of super spreaders helps to develop targeted marketing strategies in an optimal way (e.g. place advertisements on the walls and blogs of influential individuals in online social networks) which in turn supports the efficient spreading of information through online social media.

Conventional techniques for identifying influential individuals suffer from a major drawback in that they try to identify the structural importance of a single node (a single person in the network) completely or partially independent of the importance of other nodes. As a result the eventual set of influential nodes found for any network is a sub-optimal solution. The disclosed method takes into account the complex interconnectivity of a network and identifies an optimal (i.e. minimal) set of nodes that are capable of spreading information in the entire network in the fastest possible way, thus facilitating viral spreading marketing campaigns.

The disclosed method is equally applicable in creating a containment plan against a possible viral outbreak and identifying weak infrastructural links in networks such as computer networks, electrical power grids and roads. Other applications include protein-protein interaction networks in cellular biology, air transport networks in transportation systems, cell phone communication towers in communication engineering, social collaboration networks of movie actors or researchers in sociology, development strategies of cities in urban geography. In brief, wherever real-world interconnected systems can be modeled as networks with nodes and edges, the disclosed method can be used to identify influential nodes, which in turn can be utilized in several different ways to solve real-world problems.

In a broader sense, influence is deeply related to the concept of cohesion of a network: the most influential nodes are the ones forming the minimal set that guarantees a global connection of the network. This minimal set is referred to as the ‘optimal influencers’ of the network. At a general level, the optimal influence problem can be stated as follows: find the minimal number of nodes which, if removed, would break down the network into many disconnected pieces. The natural measure of influence is, therefore, the size of the largest connected component as the influencers are removed from the network.

An optimization theory of influence in complex social networks is provided herein. A network composed of N nodes tied with M links with an arbitrary degree distribution is considered. A certain fraction q of the total number of nodes may be removed. It is well known from percolation theory that, if these nodes are removed randomly, the network undergoes a structural collapse at a certain critical fraction where the probability of existence of the giant connected component vanishes, G=0. The optimal influence problem corresponds to finding the minimum fraction q_{c} of influencers to fragment the network: q_{c}=min{q∈[0,1]: G(q)=0}.

Let the vector n=(n₁, . . . , n_{N}) represent which node is removed (nᵢ=0, influencer) or left (nᵢ=1, the rest) in the network (q=1−1/NΣᵢnᵢ), and consider a link from i→j. The order parameter of the percolation transition is the probability that i belongs to the giant component in a modified network where j is absent v_{i→j}.

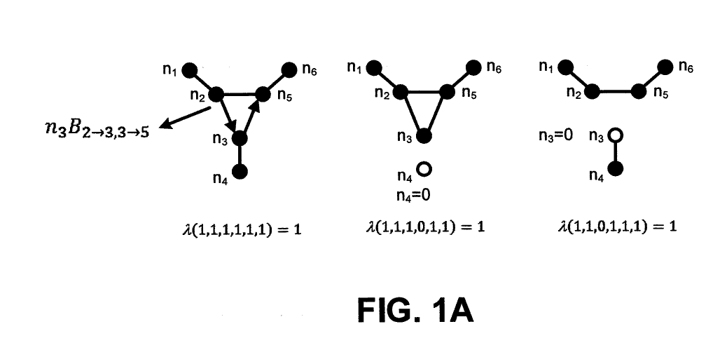

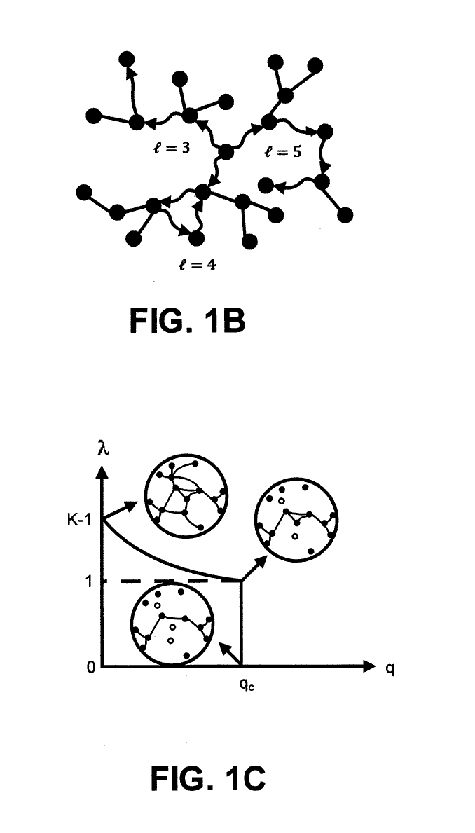

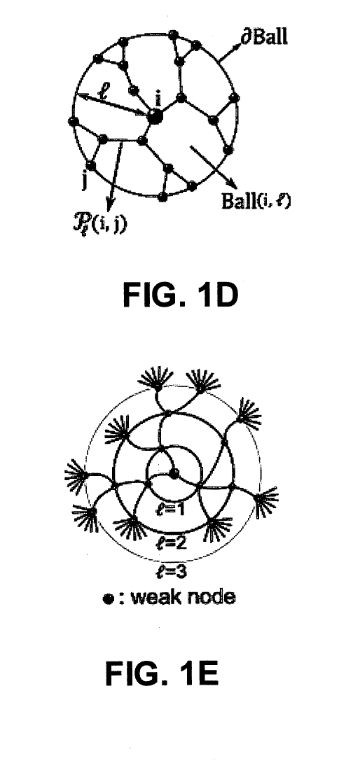

Clearly, in the absence of a giant component the solution {v_{i→j}=0} holds true for all i→j. The stability of the solution {v_{i→j}=0} is controlled by the largest eigenvalue λ(n; q) of the linear operator [symbol] defined on the 2M×2M directed edges as (see FIG. 1A)

[symbol]

_{i→j}=nᵢ [symbol] _{i→j} (1)

where [symbol] _{i→j} is the non-backtracking matrix. FIG. 1A depicts the largest eigenvalue λ of [symbol] exemplified on a simple network. The optimal strategy for spreading minimizes λ by removing the minimum number of nodes (optimal influencers). In the left panel of FIG. 1A, the entry [symbol] _{3→5}=n₃ [symbol] _{3→5}=n₃ encodes the occupancy (n₃=1) or vacancy (n₃=0) of node 3. In this particular case, the largest eigenvalue is λ=1. In the center panel of FIG. 1A, non-optimal removal of a leaf, n₄=0, which does not decrease λ. In the right panel of FIG. 1A, optimal removal of a loop, n₃=0, which decreases λ to zero. The matrix [symbol] _{i→j} has non-zero entries only when (k→l, i→j) form a pair of consecutive non-backtracking directed edges, i.e. (k→l, l→j) with j≠k. In this case [symbol] _{l→j}=1. Powers of the matrix [symbol] count the number of non-backtracking walks of a given length in the network (see FIG. 1B), much in the same way as powers of the adjacency matrix count the usual number of paths. FIG. 1B depicts an example of non-backtracking (NB) walks. A NB walk is a random walk that is not allowed to return back along the edge that it just traversed. A NB open walk ( [symbol] =3), a NB closed walk with a tail ( [symbol] =4), and a NB closed walk with no tails ( [symbol] =5) are shown. Operator [symbol] is also important in graph theory due to its high performance in the problem of community detection. Its formidable topological power in the influence optimization problem is shown next.

Stability of the solution {v_{i→j}=0} requires λ (n; q)≤1. The optimal influence problem for a given q(≤q_{c}) can be rephrased as finding the optimal configuration n that minimizes the largest eigenvalue λ (n; q) over all possible configurations n (see FIG. 1C). FIG. 1C is a representation of the global minimum over n of the largest eigenvalue λ of [symbol] versus q. When q≥q_{c}, the minimum is at λ=0. When q<q_{c}, the minimum of the largest eigenvalue is always λ>1. At the optimal percolation transition, the minimum is at n* with λ(n*, q_{c})=1. The optimal set n* of Nq_{c} influencers is obtained when the minimum of the largest eigenvalue reaches the critical threshold:

λ(n*;q_{c})=1 (2)

In the optimized case, the method selects the set nᵢ=0 optimally to find the best configuration n* with the lowest qₖ according to Eq. (2). The eigenvalue λ(n) (from now q is omitted λ(n; q)≡λ(n), which is always kept fixed) determines the growth rate of an arbitrary vector w₀ with 2M entries after [symbol] iterations of the matrix [symbol] : | [symbol] (n)|=| [symbol] w₀|˜ [symbol] . More precisely:

$$λ ( n ) = {lim}_{𝓁 \to ∞} {[ \frac{\vert {w}_{𝓁} ( n ) \vert}{\vert {w}_{0} \vert} ]}^{1 / 𝓁} \qquad ( 3 )$$

Equation (3) is the starting point of an (infinite) perturbation series which provides the exact solution to the many-body influence problem and therefore contains all physical effects, including the collective influence. In practice, the cost energy function of influence | [symbol] (n)| is minimized for a finite [symbol] . The solution rapidly converges to the exact value as [symbol] →∞, the faster the larger the spectral gap. For [symbol] ≥1:

| [symbol] (n)|²=Σᵢ₌₁^{N}(kᵢ−1) [symbol] ( [symbol] nₖ)(kⱼ−1) (4)

where Ball(i, [symbol] ) is the set of nodes inside a ball of radius [symbol] around node i, ∂Ball(i, [symbol] ) is the frontier of the ball and [symbol] (i,j) is the shortest path of length [symbol] connecting i and j (see FIG. 1D), and kᵢ is the degree of node i.

The case of zero radius [symbol] =0 leads to <w₀| [symbol] |w₀>=Σᵢ^{N}kᵢ(kᵢ−1)nᵢ. Here, there is no interaction between the nodes and the minimization of λ(n) over n naturally leads to the high degree (HD) ranking as the zero-order naive optimization in the disclosed method.

The next level in the collective influence optimization in Eq. (4) is [symbol] =1. The term |w₁(n)²|=Σ_{i,j=1}^{N}Aᵢⱼ(kᵢ−1)(kⱼ−1)nᵢnⱼ is found, where Aᵢⱼ is the adjacency matrix. This term is interpreted as the energy of an antiferromagnetic Ising spin model with random bonds in a random external field at fixed magnetization, which is an example of an NP-complete spin glass problem.

For [symbol] ≥2, the problem can be mapped to a statistical mechanical system with many-body interactions which can be recast in terms of a diagrammatic expansion. For example, w₂(n)² leads to 4-body interactions, and, in general, the energy cost [symbol] (n)² contains 2 [symbol] -body interactions. When [symbol] ≥2 an extremal optimization (EO) method can be used to find the optimal configuration. This method estimates the true optimal value of the threshold by finite-size scaling following extrapolation to [symbol] →∞. However, EO is not scalable to find the optimal configuration in large networks in present day social media. For example, EO becomes untenable for networks larger than about one hundred users. Therefore, an adaptive method was developed, which performs excellently in practice, preserves the features of the EO, and is highly scalable to present-day big data. The disclosed method is applicable to networks with over 100 people, and in some embodiments, over one million people. In still other embodiments, 100 million or more people are present in the network.

Thus a method is provided to identify super spreaders called Collective Influence (CI). In one embodiment, the CI method is implemented in C++. It takes as input a social network and outputs a ranking of influential spreaders. The method is described below:

First, a ball of radius [symbol] around every node is defined (see FIG. 1D). Then, the nodes belonging to the frontier ∂Ball(i, [symbol] ) are considered and node i is assigned the collective influence (CI) strength at level [symbol] following Eq. (4):

CI [symbol] (i)=(kᵢ−1) [symbol] (kⱼ−1) (5)

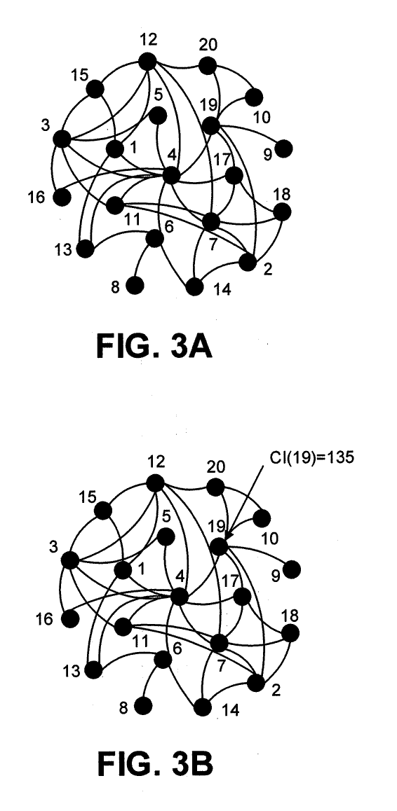

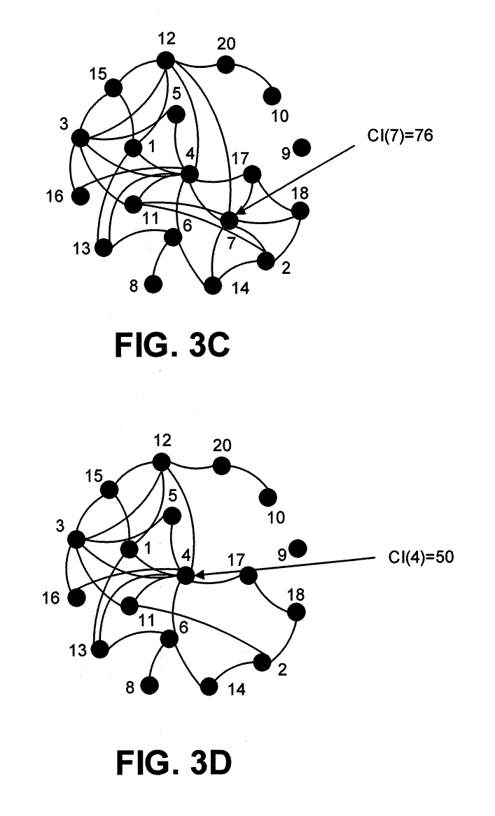

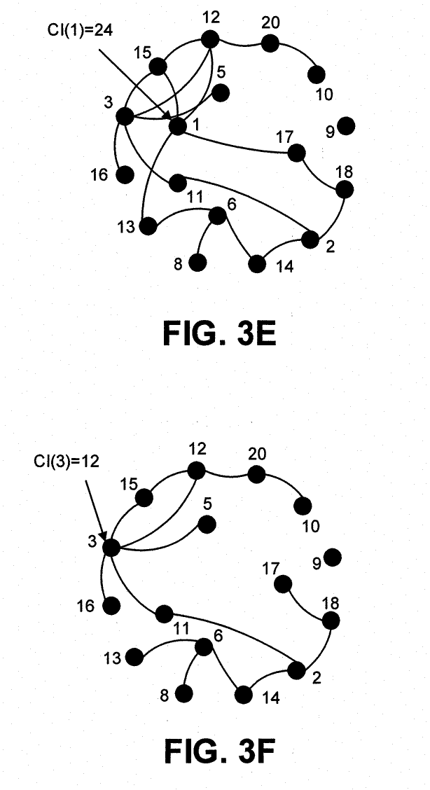

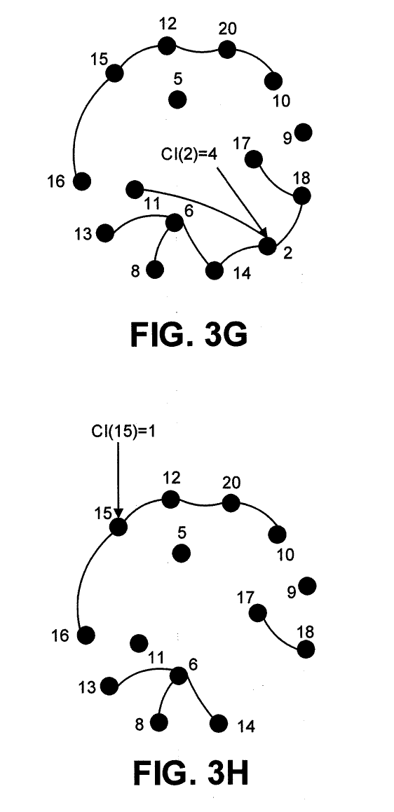

Once the CI is calculated for every node, the nodes are ranked with respect to CI and the node having the highest value of CI, say node i*, is considered to be the most influential node in the network. Then, node i* is removed from the network and set n_{i*}=0, and the degree of each neighbor of i* is decreased by one. Using the obtained reduced network, the procedure is repeated to find the new top CI node. This top CI node is assigned as the second most important influencer and then removed from the network along with all its links. The method then proceeds by identifying the next top CI node and then removing it. The method is terminated when all top influencers are identified. This corresponds to the minimum number of influencers that reduces the giant connected component of the network to zero, G=0. Thus, the CI method is terminated when the last influencer is identified and G=0. The CI method is illustrated in FIGS. 3A to 3I, where it is shown how the CI method finds the most influential people to target in a viral marketing campaign in a small portion of the TWITTER® social network for illustrative purposes.

Increasing the radius [symbol] of the ball improves the approximation of the optimal exact solution as [symbol] →∞ (for finite networks, [symbol] does not exceed the network diameter).

The collective influence [symbol] for [symbol] ≥1 has a rich topological content, and consequently gives more information about the role played by nodes in the network than the non-interacting high-degree hub-removal strategy at [symbol] =0, CI₀. The augmented information comes from the sum in the right hand side of Eq. (5), which is absent in the naive high-degree rank. This sum contains the contribution of the nodes living on the surface of the ball surrounding the central vertex i, each node weighted by the factor kⱼ−1. This means that a node placed at the centre of a corona irradiating many links—the structure hierarchically emerging at different [symbol] levels as seen in FIG. 1E—can have a very large collective influence, even if it has a moderate or low degree. Such ‘weak nodes’ can outrank nodes with larger degree that occupy mediocre peripheral locations in the network.

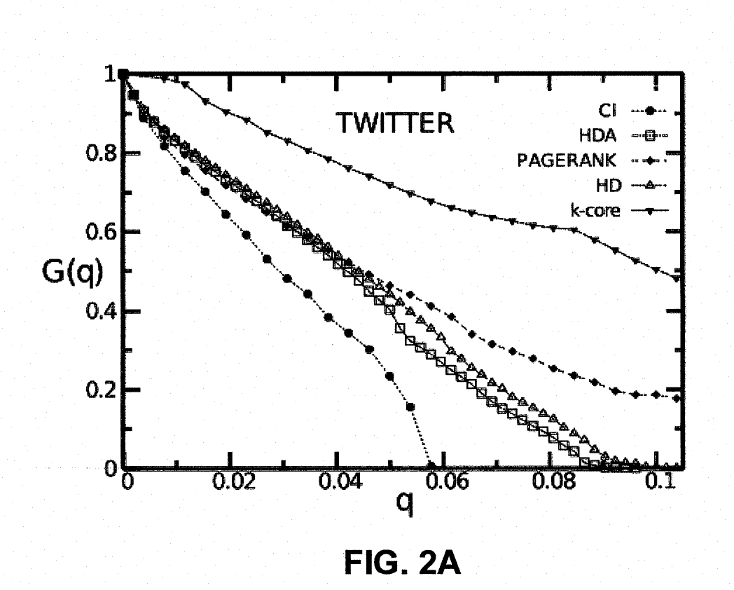

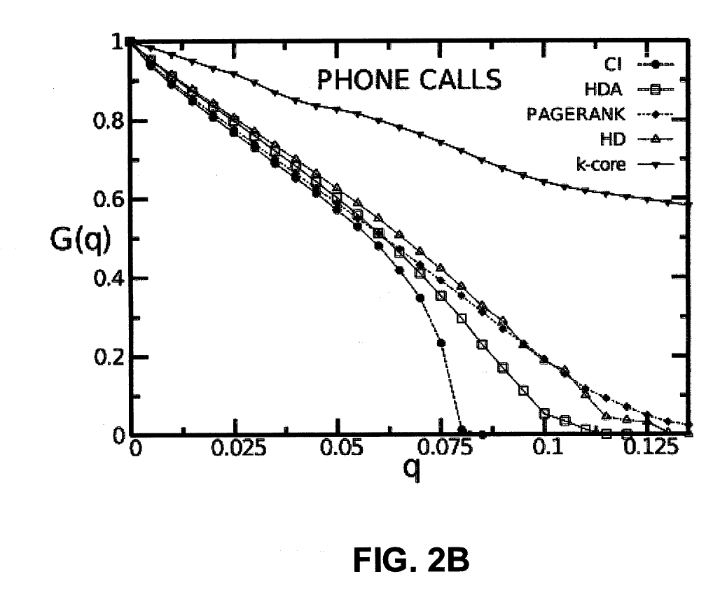

As an example of an information spreading network, the web of TWITTER® users is considered. TWITTER® is the online social networking and microblogging service that has gained world-wide popularity. A dataset of approximately 16 million tweets sampled between Jan. 23 and Feb. 8, 2011 is used. From these tweets the mention network is extracted. Mentions are tweets containing @username and usually include personal conversations or references. In fact, the mention links have stronger strength of ties than follower links. Therefore, the mention network can be viewed as a stronger version of interactions between TWITTER® users. In the mention network, if user i mentions user j in his/her tweets, there exists a link from i to j. In order to better represent the social contacts, the retweet relations from the tweets are also added to the network. A retweet (RT @username) corresponds to content forward with the specified user as the nominal source. If user i retweets a tweet of user j, then a contact is established between j and i. In this way, the social network of Twitter is constructed. The resulting network has N=469,013 nodes and M=913,457 links. As explained above, the collective influence of a group of nodes is measured as the drop in the size of the giant component G which would happen if the nodes in question were removed from the network. The results in FIG. 2A show the giant connected component G of the Twitter network as a funtion of the fraction q of nodes removed following different strategies: the CI method, High-Degree (HD), High-Degree Adaptive (HDA), PAGERANK® and k-core. This plot shows the better performance of CI in comparison with HDA, PAGERANK®, HD and k-core, since CI is able to fragment the giant component G=0 with the smallest fraction q of influencers. Thus, CI identifies the optimal influencers as opposed to the other strategies which are non-optimal. The plot also reveals that many individuals with a large number of followers (high degree) have a small influence on the network and are poor spreaders of information. This indicates that people with a large number of connections are not necessarily the most influential individuals in the network.

As shown in FIG. 3A, to illustrate how the CI method finds the most influential people to target in TWITTER®, a small portion of the full network is extracted, composed of 20 people and 36 links. The parameter [symbol] in the CI method is set to [symbol] =2. The topological structure of the network is the individuals and the social network links relating those individuals. The detailed step by step explanation of the method in this specific case is provided in FIGS. 3A to 3I.

In FIG. 3B, the method finds the individual with the highest CI value. In the embodiment of FIG. 3B, individual 19 with a CI value of 135 is found. This value is calculated according to Eq. (5) as follows. First the number of connections minus one of individual number 19 is considered: k₁₉−1=6−1=5. Then all the people two links away from individual 19 are considered (i.e. [symbol] =2), which are the individuals numbered 7, 14, 11, 16, 12, 3, 13, 1, 18. The number of connections minus one of those individuals are considered: k₇−1=4; k₁₄−1=3; k₁₁−1=2; k₁₆−1=2; k₁₂−1=5; k₃−1=4; k₁₃−1=2; k₁−1=3; k₁₈−1=2; and then summed up: (k₇−1)+(k₁₄−1)+(k₁₁−1)+(k₁₆−1)+(k₁₂−1)+(k₃−1)+(k₁₃−1)+(k₁−1)+(k₁₈−1)=4+3+2+2+5+4+2+3+2=27. Then this sum is multiplied by k₁₉−1=5, to get the final result: (k₁₉−1)×27=5×27=135. Individual 19 is assigned as the first target in the marketing campaign and then removed from the network along with all its links. Then, the number of connections of all the people linked with individual 19 are decreased by one and the CI values of those individuals are re-calculated. These are the individuals numbered 20, 17, 10, 9, 4, 2. The number of connections of those individuals before the removal of individual 19 is: k₂₀=3, k₁₇=4, k₁₀=2, k₉=1, k₄=7, k₂=4. After the removal of individual 19 the number of connections of people numbered 20, 17, 10, 9, 4, 2 are: k₂₀=2, k₁₇=3, k₁₀=1, k₉=0, k₄=6, k₂=3.

In FIG. 3C, the method finds the next individual with the highest CI value. In the embodiment of FIG. 3C, individual 7, whose CI value is 76 is found. As before, individual 7 is removed from the network along with all its links, and the number of connections of all people linked with individual 7 are decreased by one. This process is repeated until the CI value for all individuals in the network is zero. For example, in FIG. 3D, individual 4 with a CI value of 50 is found and removed. In FIG. 3E, individual 1 with a CI value of 24 is found and removed. In FIG. 3F, individual 3 with a CI value of 12 is found and removed. In FIG. 3G, individual 2 with a CI value of 4 is found and removed. In FIG. 3H, individual 15 with a CI value of 1 is found and removed. In FIG. 3I, the remaining individuals have a CI value of zero indicating those individuals are not targeted in the marketing campaign.

In one embodiment, the method outputs a rank order with regard to influential individuals within the social network. For example, in the embodiment of FIGS. 3A to 3I, the rank order is individuals 19, 7, 4, 1, 3, 2 and 15.

To further investigate the applicability of the CI method in real large-scale social network, a social contact network built from the mobile phone calls between people in Mexico is considered. A mobile phone call social network reflects people's interactions in social lives, and represents a proxy of a human contact network. In order to build the network, a link between two people is established if there is a reciprocal phone call between them in an observation window of three months (i.e. a call in both directions), and the number of such reciprocal calls is larger than or equal to three. This criterion gives a network of N=14, 346, 653 people, with an average degree [symbol] k [symbol] =3.53 and a maximum degree kₘₐₓ=419. The phone call network is the prototype of big-data, where a scalable (i.e. nearly linear) method, such as the CI method, is mandatory. The result of the CI method, compared to HDA, PAGERANK®, HD and k-core, is shown in FIG. 2B. CI is better by a very good margin. Indeed, it fragments the network using about 500,000 people less than the best heuristic strategy (HDA).

As shown in FIG. 2A and FIG. 2B the CI method is compared with Degree Centrality (HD), Adaptive Degree Centrality (HDA), PAGERANK® (PR) and k-core methods. Two real-world networks are used TWITTER® (FIG. 2A) and Phone Calls (FIG. 2B) to test the resilience of these networks if the most influential nodes are removed from the network. Y-axis represents the size of the largest connected component and X-axis represents the fraction of nodes removed from the network using one of methods. CI clearly outperforms all other methods in identifying influential nodes responsible of keeping the entire network connected. For example, in FIG. 2A, the CI method identifies a minimum number of influential nodes (q less than 0.06) to fragment the network (G=0). In contrast, HDA required more nodes (q of about 0.09) to fragment the network while HD required even more nodes (q of about 0.1) and PAGERANK® is even less optimal. Likewise, in FIG. 2B, the CI method identifies a minimum number of influential nodes (q of about 0.08) to fragment the network (G=0). HDA (q of about 0.11) and HD and PAGERANK® (q of about 0.12) required more nodes to fragment the network. This demonstrates the CI method can identify key nodes more effectively than either the HDA or HD and PAGERANK® methods.

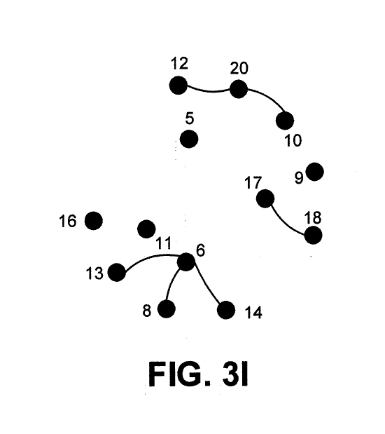

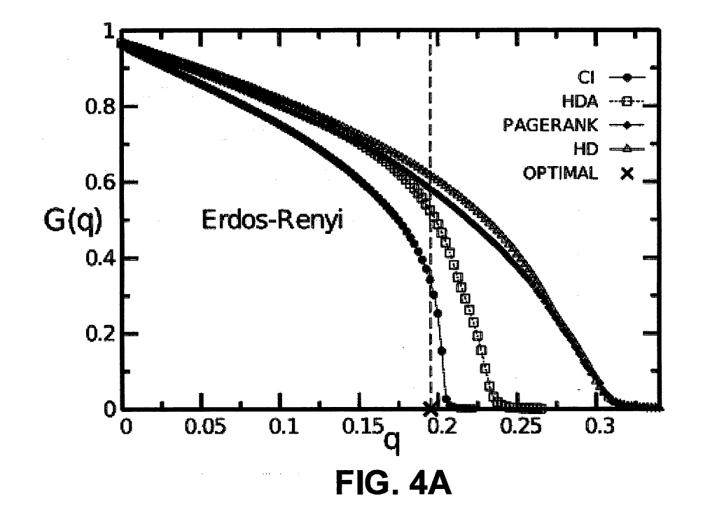

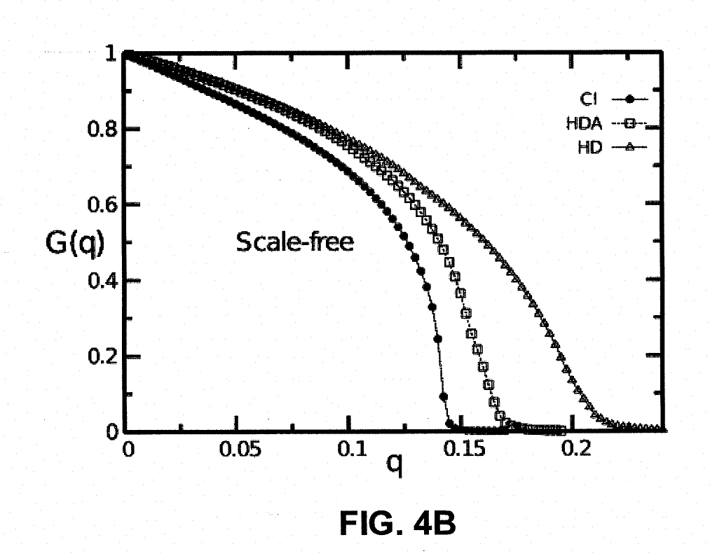

As shown FIG. 4A and FIG. 4B, the disclosed method was also tested on two synthetic networks, a random Erdos-Renyi network and a scale free network. Again the results clearly show that the disclosed CI method is more efficient as compared to HDA, PAGERANK® and HD methods. Two synthetic networks are used: Random Network-Erdos Renyi (FIG. 2A) and Scale Free network (FIG. 2B) to test the methods. Y-axis represents the size of the largest connected component and X-axis represents the fraction of nodes removed from the network using one of methods. CI clearly outperforms all other strategies in identifying influential nodes responsible of keeping the entire network connected.

It is commonly believed that patterns of social ties affect individuals' economic status. This concept may be translated into an operational definition at the network level, which allows one to develop a targeted marketing strategy to identify customers based on a measure of their location and influence in the social network. To probe this point, two large-scale sources are analyzed: telecommunications and financial data of a whole country's population. The results show that an individual's location in the network, measured by the Collective Influence CI metric defined in Eq. (5) is highly correlated with personal economic status. CI ranks the people in the social network and the top ranked people are those with the highest economic level. This result allows one to develop a targeted marketing campaign to directly target the people with the highest economic level. First, the people in the network are ranked according the CI metric Eq. (5). At the top of the rank is the person with the highest value of CI. Every person in the rank is identified according by their CI value from top to bottom. The ranking of people is then used to target people to offer them products via advertisement. The response rate, defined as the number of people that respond to the offer of a given product, is measured. This defines the targeted marketing campaign based on the CI metric. This marketing campaign was carried out (Nature Communications; May 16, 2017 Inferring personal economic status from social network location.). This method obtained a threefold increase in response rate by targeting individuals identified by the disclosed social network metrics as compared to random targeting. The strategy can also be useful in maximizing the effects of large-scale economic stimulus policies.

The long-standing problem of how the network of social contacts influences the economic status of individuals has drawn large attention due to its importance in a diversity of socioeconomic issues ranging from policy to marketing. Theoretical analyses have pointed to the importance of the social network in economic life as a medium to diffuse ideas through the effects of ‘structural holes and ‘weak ties’ in the network. Likewise, research has recognized the positive economic effect of expanding an individual's contacts outside its own tightly connected social group. While previous work has established the importance of social network influence to economic status, the problem of how to quantify such correspondence via social network centralities or metrics remains open.

Studies employing mobile phone communication data and other social indicators have found a variety of network effects on socioeconomic indicators such as job opportunities, social mobility, economic development and consumer behavior. Recent work also provides evidence of such effects on an individual's wealth, and highlights the need for better indicators. A numerical study has tested the effect of network diversity on economic development. This study analyzed economic development defined at the community level. However, the question of how social network metrics may be used to infer financial status at the individual level—necessary, for instance, for micro-target marketing or social intervention campaigns—still remains unanswered. The difficulty arises, in part, due to the lack of empirical data combining an individual's financial information with the pattern of their social ties at the large-scale network level of the whole society.

This disclosure addresses this problem directly by combining two massively large data sets: a social network of the whole population of a Latin American country and financial banking data at the individual level. The optimality of an individual's location in the network was discovered, which is measured by the collective influence (CI) metric, is highly correlated with the individual's economic status at the population level: the larger the CI, the higher the socioeconomic level. The goodness of fit of this correlation can be as high as R²=0.99 when age is also included. These results indicate that the location's optimality in the social network measured by the CI metric can accurately predict socioeconomic indicators at the personal level.

The top 1% of the economic stratum has precise network patterns of ties formation showing relatively low local connectivity surrounded by a hierarchy of hubs strategically located in spheres of influence of increasing size in the network. Such a pattern is not observed in the rest of the population and in particular, in the bottom 10% characterized by low values of CI. Thus, the influence measured from social network patterns mimics the inequality observed in economic status.

A high correlation was found between the link diversity of individuals and their financial status (R²=0.96), employing the analysis based on network location and age. Analysis of the covariance suggests that the effect of network influence is significant and independent from other factors. These results were validated by carrying out a targeted marketing campaign in which the response rate for different groups of people was compared with different network locations. By targeting the group with the top CI values, the response rate can reach as high as 1%; approximately three times the response rate found by random targeting and five times the response rate of the low CI people.

Thus, individuals with high socioeconomic status (top 1%) develop a very characteristic pattern of social ties as compared to the bottom 10%. While this result may be expected, it is remarkable that the difference in pattern of social interactions between the rich and the poor can be precisely captured by a network metric measuring their CI in the social network.

The top socioeconomic layer of society also represents the minimal set of people that provides integrity to the whole social network through their large CI. The fact that individuals of higher economic status are located in regions of large CI in the network elevates previous anecdotal evidence to a principle of network organization through the optimization of influence of affluent people affecting the structural integrity of the social network. At the same time, it suggests the emergence of the phenomenon of CI in society as the result of the optimization of socioeconomic interactions.

Network construction. The social network is constructed from mobile (calls and SMS metadata) and residential communications data collected for a period of 122 days. The database contained 1.10×10⁸ phone users. After filtering the non-human active nodes by a machine-learned model trained on human natural communication behavior, a final network of 1.07×10⁸ nodes was constructed in a giant connected component made of 2.46×10⁸ links. The ties, or links, in the network correspond to phone call communications, because communication patterns are expected to be indicative of an individual's location in the social network. The financial cost of using phone services makes it possible that there is a systematic bias in how much wealthy individuals use the phone services relative to people that have less money to spend on phone calls. Although the effect might be limited, this possibility cannot be ruled out with the present data.

Financial status is obtained from the combined credit limit on credit cards assigned by banking institutions to each client. The credit limit is based on composite factors of income and credit history and therefore reflects the financial status of the individual. The credit limit is pulled from an encrypted bank database and identified by the encrypted clients' phone numbers registered in the bank. Thus, one is able to precisely cross-correlate the financial information of an individual with their social location in the phone call network at the country level. There are 5.02×10⁵ bank clients who have been identified in the mobile network whose credit limit ranges from USD $50 to $3.5×10⁵ (converted from the country of study). Thus, the data sets are precisely connected providing an unprecedented opportunity to test the correlation between network location and financial status.

The communication patterns that are geolocalized across the country of individuals in the top 1% and bottom 10% of credit limits can be determined as described. The inequality in the patterns of communication between the top economic class and the lowest is striking and mimics the economic inequality at the country level. It is apparent that the top 1% (accounting for 45.2% of the total credit in the country) displays a completely different pattern of communication than the bottom 10%; the former is characterized by more active and diverse links, especially connecting remote locations and communicating with other equally affluent people. Further results using entropy analysis also suggest that the network structure may be significantly different between the people in the top and bottom quantile rankings of credit limit. Particular examples of the extended ego-networks for two individuals (with same number of ties) ranking in the top 1% and bottom 10% provide a zoomed-in picture of such differences. The wealthiest 1-percenters have higher diversity in mobile contacts and are centrally located, surrounded by other highly connected people (network hubs). On the other hand, the poorest individuals have low contact diversity and are weakly connected to fewer hubs. The crux of the matter is to find a reliable social network metric to quantify this visual difference in the patterns of network structure between the rich and the poor.

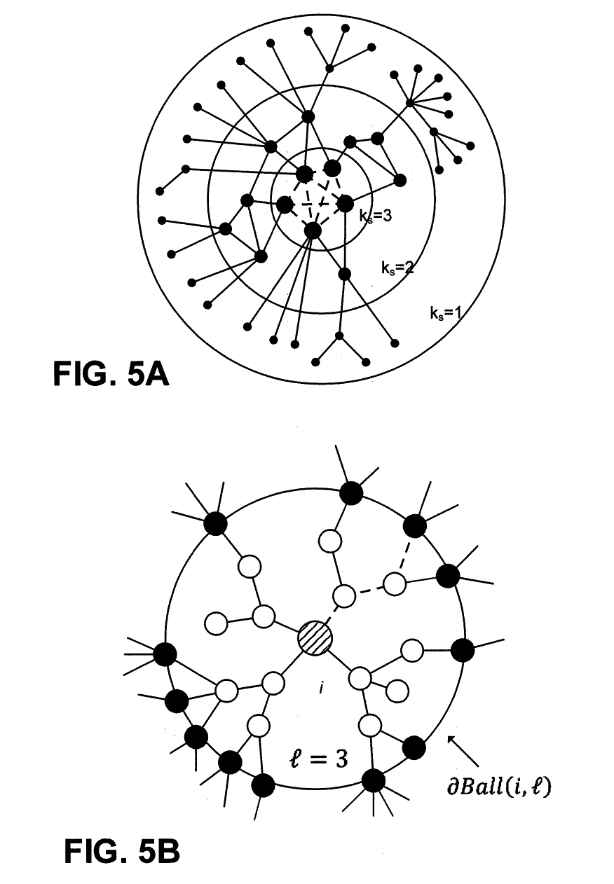

Network influence and financial status. Many metrics or centralities have been considered to characterize the influence or importance of nodes in a network. The following section considers only those centralities that can be scaled up to the large network size considered here (FIG. 5A, FIG. 5B): (a) degree centrality kᵢ (number of ties of individual i) is one of the simplest, (b) PageRank, of Google fame, is an eigenvector centrality that includes the importance of not only the degree, but also the nearest neighbors, (c) the k-shell index kₛ of a node (FIG. 5A), that is, the location of the shell obtained by iteratively pruning all nodes with degree k<kₛ), and (d) the CI of a node with degree kᵢ (FIG. 5B) in a sphere of influence of size [symbol] defined by the frontier of the influence ball ∂Ball(i, [symbol] ) and predicted to be CI=(kᵢ−2) [symbol] (kⱼ−1) by optimal percolation theory. As opposed to the other heuristic centralities, CI is derived from the theory of maximization of influence in the network. The top CI nodes are thus identified as top influencers or superspreaders of information, and they are so by positioning themselves at strategic locations at the center of spheres surrounded by hubs hierarchically placed at distances [symbol] . These collective influencers also constitute an optimal set that provides integrity to the social fabric: they are the smallest number of people that, upon leaving the network (a process mathematically known as optimal percolation), would disintegrate the network into small disconnected pieces.

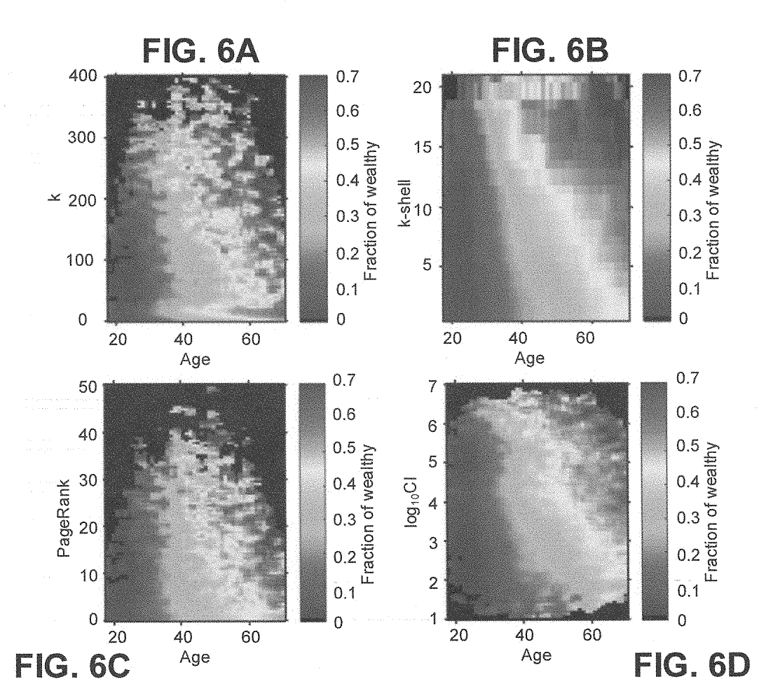

By definition, all the metrics have similarities (for example, they are proportional to k, and PAGERANK® and CI are based on the largest eigenvalues of the adjacency and non-backtracking matrices, respectively), and indeed, their values in the phone communications network are correlated. More interestingly, FIG. 6A, FIG. 6B, FIG. 6C and FIG. 6D provide evidence of correlation of the four network metrics with financial status (ranked credit limit) when controlled for age, indicating that the network location correlates with financial status. In these figures, the fraction of wealthy individuals (defined as top 4th quantile, equivalent to a credit limit greater than USD $4,000) was plotted in a sampling grid for a given value of age and social metric as indicated.

While all the social metrics show correlations with financial status when considered with age (FIG. 6A-D), the question remains of which metric is the most efficient predictor. Strong correlations with economic wellness are observed for the feature pairs (age, k-shell; R²=0.96, FIG. 6B) and (age, CI; R²=0.93, FIG. 6D). Between these two metrics, CI guarantees a requirement for both strong correlation and sufficient resolution. K-shell cannot capture further details due to its limitation of values (k-shell ranges from 1 to 23, dividing the whole population into this small number of shells with a typical shell containing tens of millions of people), while CI spans over seven orders of magnitude. This high resolution implies that CI is a more accurate social signature for the financial status of the individuals. According to its definition, a top CI node is a moderate-to-strong hub surrounded by other hubs hierarchically placed at distance [symbol] . However, one should emphasize that CI is just a useful strategy for the reasons shown above, and by no means the only or best strategy to correlate the wealth of individuals and their network influence.

While the theory behind CI is a global maximization of influence, CI represents the local approximation to this global optimization. Thus, CI represents a balance between a global optimization and its local approximation, taking into account the first 2 or 3 layers of neighbors via the parameter [symbol] , which represents the size of the sphere of influence used to define the importance of a node. By changing [symbol] , one discovers that CI with [symbol] =2 is sufficient to capture the correlation between network influence and wealth.

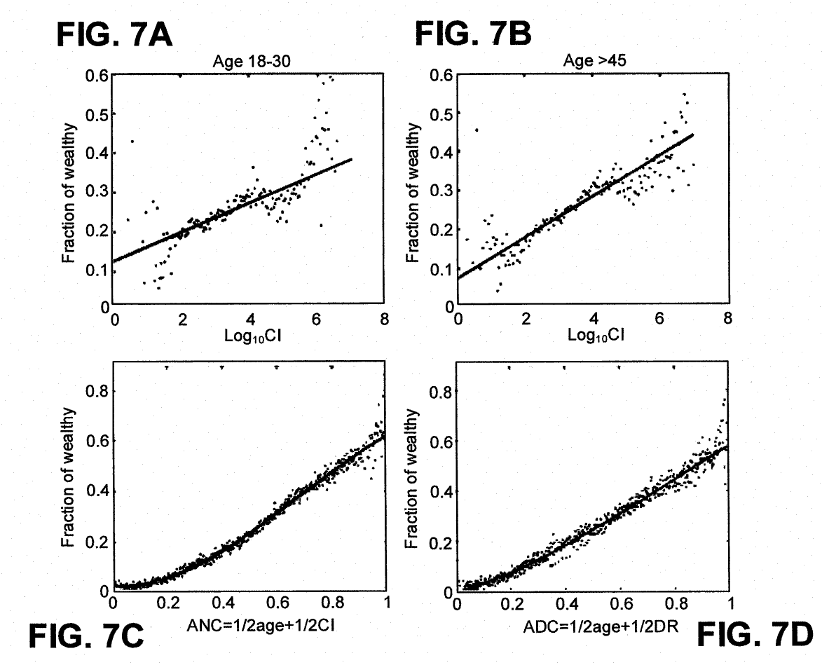

To track the effect of CI independently of age, the effects of CI inside two specific age groups were investigated in FIG. 7A, FIG. 7B. In both age groups, high CI is always accompanied by a higher population of wealthy people. A relatively smaller slope in age group less than 30 suggests that the CI network effect is more sensitive for older people with more mature and stable economic levels, than for younger people. When age and CI quantile ranking are combined into an age-network composite: ANC=αAge+(1−α) CI, with a α=0.5, a remarkable correlation (R²=0.99, FIG. 7C) is achieved. By combining network information with age, the probability to identify individuals with a high credit limit reaches about 70% at the highest earner level. Such a level of accuracy renders the model practical to infer individuals' financial fitness using network CI.

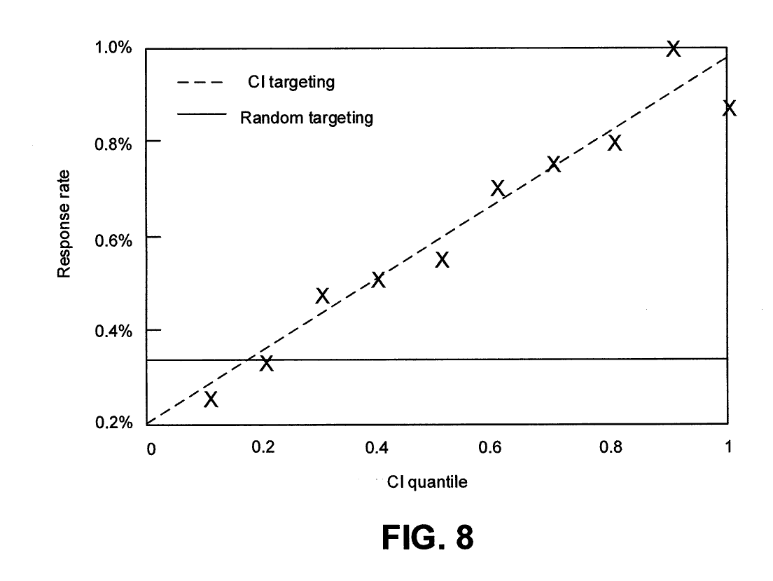

Validation by marketing campaign. To validate the disclosed strategy, a social marketing campaign was performed whose objective is the acquisition of new credit card clients, by sending messages to affluent individuals (as identified by their CI values) and inviting the recipients to initiate a product request. In this experiment an independent data set from a different time frame was used, and only the CI values extracted from the network were used to classify the targeted people. Specifically, the communications network resulting from the aggregation of calls and SMS exchanged between users over a period of 91 days was used. The resulting social network contains 7.19×10⁷ people and 3.51×10⁸ links. The campaign was conducted on a total of 656,944 people who were targeted by an SMS message offering the product according to their CI values in the social network. Messages were also sent to a control group of 48,000 people, chosen randomly. To evaluate the campaign, the response rate was measured, that is, the number of recipients who requested the product divided by the number of targeted people, as a function of CI. In the control group, the response rate to the messages was 0.331%. The results show that groups of increasing CI show an increase in their response rate, with a sound threefold gain in the rate of response of the top influencers (as identified by top CI values) when compared to the random case. When the response of the high CI is compared to the lowest CI people, the response rate increase fivefold. The results of the experiment are summarized in Table 1 and FIG. 8.

TABLE 1
Results of the real-life marketing campaign

| | | | Answered | Response |
|---|---|---|---|---|
| CI range | Count | Quantile | yes | rate |
| (0; 48) | 66,495 | 0.1 | 170 | 0.26% |
| (48; 246) | 65,164 | 0.2 | 218 | 0.33% |
| (246; 600) | 65,961 | 03 | 316 | 0.48% |
| (600; 1,144) | 65,376 | 0.4 | 332 | 0.51% |
| (1,144; 1,992) | 65,477 | 0.5 | 363 | 0.55% |
| (1,992; 3,408) | 65,477 | 0.6 | 458 | 0.70% |
| (3,408; 6,032) | 65,736 | 0.7 | 493 | 0.75% |
| (6,032; 11,772) | 65,641 | 0.8 | 555 | 0.8% |
| (11,772; 28,740) | 65,683 | 0.9 | 657 | 1.0% |
| (28,740; 2,719,354) | 65,683 | 1.0 | 573 | 0.87% |

Individuals (“Count”) were targeted according to their quantile CI rank in the whole social network obtained from phone communications activity. The response to the campaign (‘Answered yes’) was computed to calculate the Response rate.

Analysis of covariance. The validation is indirect because it is not a direct prediction of financial status, but a rate of successful response to a marketing campaign. This success rate may depend on a number of other factors that may correlate with the network centrality. Thus, the CI metric may not necessarily be the only cause of the success rate of the targeted campaign (for instance, geographical location may be also important). To address this point, an analysis of covariance was performed on all of the available features (age, gender and registered zip code) to test the variance caused by the network metrics and other factors. Analysis of covariance shows that the effects of the network metrics are independent from those of the other factors. The correlation between the CI and the fraction of wealthy people is positive and significant (P less than 0.001) in all groups of geographical communities, across genders, and among all age groups older than 24 years. The same significant results are also obtained under different thresholds of wealth. Such significant and robust network effects imply that network metrics may be a potential indicator for financial status.

Network diversity and financial status. Combined data sets also offer the possibility to test the importance of the diversity of links, as measured by ties to distant communities in the network not directly connected to an individual's own community, at the level of single individuals. To this end, the communities in the social network were detected by applying fast fold modularity detection algorithms. The diversity of an individual's links can be quantified through the diversity ratio DR=Wₒᵤₜ/Wᵢₙ, defined as the ratio of total communication events with people outside their own community, Wₒᵤₜ, to those inside their own community, Wᵢₙ. This ratio is weakly correlated to CI (R=0.4), suggesting that it captures a different feature of network influence. The same statistics of composite ranking as before were implemented, resulting in an age-diversity composite ADC=αAge+(1−α) DR, with weight α=0.5. The result (FIG. 7D) shows that ADC correlates with individual financial well-being, generalizing the aggregated results to the individual level. Thus, the social metrics considered, DR and CI, express the fact that higher economic levels are correlated with the abilities to communicate with individuals outside one's local tightly-knit social community, a measure of Granovetter's ‘strength of weak ties’ principle and to position oneself at particular network locations of high CI that are optimal for information spreading and structural stability of the social network. No causal inference can be established with the present data.

These results highlight the possibility of predicting both financial status and benefits of socially targeted policies based on network metrics, leading to tangible improvements in social marketing also suggests the possible role of accessing and mediating information in financial opportunity and well-being. This has an immediate impact in designing optimal marketing campaigns by identifying the affluent targets based on their influential position in a social network. This finding may be also raised to the level of a principle, which would explain the emergence of the phenomenon of CI itself as the result of the optimization of socioeconomic interactions.

In general, the disclosed method assigns a ranking of influence in a social network. The method to assign this ranking is based on the contact information of a network. The method takes as input all the links of a network and assigns a rank to all the nodes on the basis of collective behavior. Examples of the types of social networks include phone call records in a mobile network, friendship-links or any kind of interaction-link between people in online social networks such as mentions and retweets in a TWITTER® network. The method is used to optimally place ads in a mobile network or social network, such as TWITTER® or FACEBOOK®. When the network structure is obtained, the disclosed CI method is used to find the minimal set of most influential people in social networks to be targeted in an advertisement campaign.

The disclosed method may be applied to a variety of networks and complex systems emerging from a number of different scientific fields. A non-exhaustive list of applications includes (1) devising strategies to increase robustness of electrical power grids across the country foreseeing possible targeted terrorist attacks or natural disaster (2) developing immunization strategies against possible virus outbreak of infectious diseases and (3) identification of weakly connected nodes in computer networks whose removal can cause global network failure.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a non-transient computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of target marketing in a social network, the method comprising steps of:
determining a topological structure of a social network, wherein the social network comprises a plurality of individuals including influential spreaders of information;
calculating a collective influence (CI) value for each individual (i) on other individuals (j) in the social network according to; [symbol]
(i)=(kᵢ−1) [symbol] (kⱼ−1)
wherein ∂Ball(i, [symbol] ) is a ball of radius link ( [symbol] ) around individual (i), the radius link ( [symbol] ) is a non-zero integer corresponding to a number of links to connect individuals (i) to other individuals (j) located on a boundary of the ball, kⱼ is a degree of individual (j);
rank ordering each individual by their respective CI value, thereby producing a rank ordered list; and
sending a targeted advertisement to the individuals in at least the top 10% of the rank ordered list but not sending the targeted advertisement to the individuals in the bottom 50% of the rank ordered list.

2. The method according to claim 1, wherein the step of sending sends the targeted advertisement to the individuals in the top 20% of the rank ordered list but not sending the targeted advertisement to the individuals in the bottom 50% of the rank ordered list.

3. The method according to claim 1, wherein the step of sending sends the targeted advertisement to the individuals in the top 30% of the rank ordered list but not sending the targeted advertisement to the individuals in the bottom 50% of the rank ordered list.

4. The method according to claim 1, wherein the step of sending sends the targeted advertisement to the individuals using a short-message-service (SMS).

5. The method according to claim 1, wherein the targeted advertisement advertises a credit offer.

6. The method according to claim 1, wherein [symbol] is a non-zero integer that is less than 10.

7. The method according to claim 1, wherein [symbol] is a non-zero integer that is less than 5.

8. The method according to claim 1, wherein the plurality of individuals comprises at least one million individuals.

9. A method of target marketing in a social network, the method comprising steps of:
determining a topological structure of a social network, wherein the social network comprises a plurality of individuals including influential spreaders of information;
calculating a collective influence (CI) value for each individual (i) on other individuals (j) in the social network according to; [symbol]
(i)=(kᵢ−1) [symbol] (kⱼ−1)
wherein ∂Ball(i, [symbol] ) is a ball of radius link ( [symbol] ) around individual (i), the radius link ( [symbol] ) is a non-zero integer corresponding to a number of links to connect individual (i) to other individuals (j) located on a boundary of the ball, kⱼ is a degree of individual (j);
rank ordering each individual by their respective CI value, thereby producing a rank ordered list; and
sending a targeted advertisement to the individuals in at least the top 20% of the rank ordered list but not sending the targeted advertisement to the individuals in the bottom 50% of the rank ordered list, wherein the targeted advertisement advertises a credit offer.

10. The method according to claim 9, wherein the plurality of individuals comprises at least one million individuals.

11. The method according to claim 9, wherein the step of sending sends the targeted advertisement to the individuals in the top 30% of the rank ordered list but not sending the targeted advertisement to the individuals in the bottom 70% of the rank ordered list.

12. The method according to claim 9, wherein the step of sending sends the targeted advertisement to the individuals in the top 40% of the rank ordered list but not sending the targeted advertisement to the individuals in the bottom 60% of the rank ordered list.

13. The method according to claim 9, wherein the step of sending sends the targeted advertisement to the individuals using a short-message-service (SMS).

14. A method of target marketing in a social network, the method comprising steps of:
determining a topological structure of a social network, wherein the social network comprises a plurality of individuals including influential spreaders of information;
calculating a collective influence (CI) value for each individual (i) on other individuals (j) in the social network according to; [symbol]
(i)=(kᵢ−1) [symbol] (kⱼ−1)
wherein ∂Ball(i, [symbol] ) is a ball of radius link ( [symbol] ) around individual (i), the radius link ( [symbol] ) is a non-zero integer corresponding to a number of links to connect individual (i) to other individuals (j) located on a boundary of the ball, kⱼ is a degree of individual (j);
rank ordering each individual by their respective CI value, thereby producing a rank ordered list; and
sending, using a short-message-service (SMS), a targeted advertisement to the individuals in at least the top 10% of the rank ordered list but not sending the targeted advertisement to the individuals in the bottom 50% of the rank ordered list, wherein the targeted advertisement advertises a credit offer.
